(19) United States
(12) Patent Application Publication
(10) Pub. No.: US 2013/0099968 A1
(43) Pub. Date: Apr. 25, 2013

(54) GNSS POSITIONING IN ELEVATOR

(71) Applicant: Daniel A. Katz, Kiryat Ono (IL)

(72) Inventor: Daniel A. Katz, Kiryat Ono (IL)

(73) Assignee: Mr. Daniel A. Katz, Kiryat Ono (IL)

(21) Appl. No.: 13/280,514

(22) Filed: Oct. 25, 2011

(51) Int. Cl. G01S 19/26; G01S 1/24; G01S 19/12

(52) U.S. Cl. 342/357.65; 342/462; 701/485; 342/387

(57) ABSTRACT

The present invention discloses a radio beacon coupled to an altimeter, for GPS positioning in an elevator, configured to broadcast signals forcing a nearby GPS receiver to read constant latitude and constant longitude, associated with the position of the elevator shaft, and altitude associated with the altimeter reading. The acquired in-elevator position can serve as an initial fix for further navigation, particularly indoors.

### BACKGROUND OF THE INVENTION

The present invention relates to the art of digital communications, particularly to radio navigation, and more precisely to satellite based radio navigation.

Global Navigation Satellite Systems (GNSS), such as the US GPS, the European GALILEO and the Russian GLONASS, are based on a mathematical concept known in the art as “three dimensional Trilateration”, where a point is determined by its distances from three other points. The point we wish to determine is the position of a GNSS receiver, typically located by the earth surface, in a car or onboard a ship or aircraft or carried by hand, while the other points are satellites orbiting around the earth. The distances between the satellites and the receiver are estimated by measuring the travelling time of signals transmitted from the satellites, at the speed of light, until arriving at the receiver. FIG. 1 illustrates the GPS Trilateration Concept.

Theoretically, three distance measurements are required to resolve the three spatial coordinates (x, y, z) of the receiver. However, practically, four satellites are monitored by the receiver, in order to account also for the receiver's clock drift, compared to the accurate satellites and system clocks.

The four basic GPS equations, referred in the art as the “navigation equations” or “range equations” or “pseudo range equations”, are represented as following:

PRᵢ−C*Δt_{SVi}=√[(x−xᵢ)²+(y−yᵢ)²+(z−zᵢ)²]+C*Δt_{R}; i=1-4 (1)

### Where:

PRᵢ=“Pseudo Range” between SVᵢ (Space Vehicle i) and receiver
C=speed of light in free space, ^{˜}300,000 Km/sec
Δt_{SVi}=SVᵢ clock deviation from “GPS Time” (the system reference time)
x, y, z=receiver position (to be determined)
xᵢ, yᵢ, zᵢ=SVᵢ position
Δt_{R}=receiver clock drift from GPS Time.

As a skilled person may appreciate, the part √[(x−xᵢ)²+(y−yᵢ)²+(z−zᵢ)²] expresses the geometrical distance between SVᵢ and the receiver, i.e. the Pythagorean Theorem in three dimensions.

On the other side of equation (1), PRᵢ also expresses the range between SVᵢ and the receiver, however as hinted by its name, PRᵢ is an approximated range. PR, expresses the travelling time between SVᵢ and the receiver, multiplied by the speed of light; yet travelling time is the difference between receiving time instant to transmission time instant of the signal, however measured by different clocks, since the receiver measures the receiving time instant and the satellite measures the transmission time instant (and reports it on the broadcast signal). This discrepancy is accounted for in the navigation equations (1), by referring to each clock deviation from the system clock, named “GPS Time”. Thus, Δt_{SVi} which stands for the SVᵢ clock deviation from the GPS Time, and Δt_{R} which stands for the receiver clock deviation from GPS Time, complement equations (1).

The basic task of a GNSS receiver is to resolve the four equations (1), determining the four unknowns: x, y, z and Δt_{R}. Prior to that, the receiver has to determine the known parameters in equations (1), i.e. PRᵢ, Δt_{SVi}, xᵢ, yᵢ, zᵢ. For this purpose, the receiver uses information broadcast by the GPS satellites.

As a person skilled in the art probably appreciates, the signals broadcast by GPS satellites are basically one or more RF carriers, modulated by two types of data streams: Pseudo-Random-Noise (PRN) codes and the navigation message.

PRN codes are pre-known series of data, cyclically transmitted by each satellite, for synchronization and ranging purposes. Each satellite is allocated with a unique code, from the same family.

PRNs obtain sharp auto-correlation and flat cross-correlation properties. Since the receiver knows in advance exactly which satellite transmits which code, it generates a replica of this code, and a correlation between this replica and the received signal means that a specific satellite signal is detected, at a specific receiving time instant.

The navigation message is a series of bits, organized in frames and sub frames, conveying navigational data, particularly indicating the location of the GPS satellites, and the transmission time instant, used by the receiver to determine the pseudorange. The navigation message comprises also the satellite clock correction information, required to determine Δt_{SVi}.

For pseudorange determination, the transmitter refers to a certain bit in the navigation message stream, for which the transmission time instant is reported. When the receiver detects this bit, it records its own time, say t_{Ri}, then decodes the transmission time instant reported in the navigation message, say t_{Ti}, and determines PRᵢ=C*(t_{Ri}−t_{Ti}). However, since the navigation message bits are quite slow, typically 50 bps, their rise time is relatively long so provide a poor accuracy for determining the receiving time instant. Yet, the PRN code, at a rate of 1.023 MHz (C/A signal), which is synchronized with the navigation message bits, is used by the receiver to refine t_{Ri}, to a level of about 1% of the PRN bit period, i.e. to 10 ns, or 3 meters in pseudo range. PR accuracy is a significant factor in position accuracy of a GPS receiver. At the beginning of 2011, GPS C/A receivers provide position accuracy of about 5 meters.

Determining the precise satellite position (xᵢ, yᵢ, zᵢ) is not straightforward, since a GPS satellite does not report its instantaneous position, but parameters of a mathematical model describing its orbit, from which its position can be calculated and extrapolated. These parameters are known in the art as “Keplerian Elements”. FIG. 2 illustrates the satellite orbit and the Keplerian Elements.

According to Kepler's 1^{st} law, GPS satellites obtain an elliptical orbit with the center of the earth at one of the ellipse foci (plural of focus). In order to define this orbit, six Keplerian elements are typically used: 2 parameters that describe the orbit shape and size, 3 parameters that describe the orbit orientation in space, and 1 parameter to determine the momentary position of the satellite on its orbit at one specific time. These parameters are repeatedly broadcast by each GPS satellite, as part of the ephemeris in the navigation message, updated every couple of hours or so.

The 6 Keplerian elements describing a GPS satellite orbit are:
i. a=semi-major axis of the ellipse
ii. e=eccentricity of the ellipse
iii. i=inclination between the orbit plane and the earth equator
iv. Ω=Right Ascension of Ascending Node (RAAN)
v. ω=argument of perigee
vi. tₒₑ=epoch of perigee passage

Basically, a GPS receiver detects the Keplerian elements (and further corrections) broadcast by the satellites, and calculates their momentary position (xᵢ, yᵢ, zᵢ).

A more comprehensive description of the reference signals broadcast by GPS satellites can be found in the GPS Interface Specification (IS) documents, and in the GPS Interface Control Documents (ICD), published by US authorities. See—http://www.gps.gov/technical/icwg/

Both, IS-GPS-200E and IS-GPS-800A, dated 8 Jun. 2010, are references to the present invention.

Satellite navigation systems such as GPS, GALILEO and GLONASS, are designed to operate in open spaces, where there is substantially a line of sight between the receiver and the satellites. However, due to their relatively high frequency (L-Band) and low signal power by the earth surface, GNSS satellite signals can be hardly detected indoors.

For indoor GNSS navigation, the present art suggests deploying an infrastructure of local transmitters that emulate satellite signals, known in the art as “Pseudolites” (“pseudo-satellites”). Pseudolites are most often small transceivers used to create a local, ground-based GPS alternative. Pseudolites are applied in situations where the normal GPS signals are either blocked/jammed (military conflicts), or simply not available (exploration of other planets), or applied to precision approach landing systems for aircraft and highly accurate tracking of transponders. In particular, Pseudolites gain more and more attention in the context of indoor location.

In large buildings, particularly multi floor buildings, deploying an infrastructure of pseudolites is problematic. Since GPS signals can hardly cross floors and walls, every floor and almost every room would require a dedicated set of pseudolites, and since these sets should be synchronized with each others, a huge cabling network would be required or alternatively dense wireless transmissions.

Another interesting technology which is been studied for indoor navigation concerns with exploiting communication infrastructure, densely deployed in urban areas, such as cellular and WLANs.

The main idea is to consider cellular base stations or wLAN Access Points as reference points for Triangulation or Trilateration, since these signals are well detected indoors, due to lower frequency and higher power compared to GPS signals.

Such base stations may broadcast their own position, and assuming time synchronized networks, a mobile device could measure the Time of Arrival (TOA) of the signal, and accordingly determine the pseudorange (or even range, if round trip signaling is feasible). Fourth generation (4G) cellular standards such as LTE are quite concerned about these features. Similar methods can be applied in wireless LAN networks, such as WIFI or WiMAX.

Yet, in order to determine a position via Trilateration/TOA with cellular/WLAN networks, at least three such base stations should be simultaneously detected. However, typically, cellular/WLAN networks are not deployed so redundantly since differently than GPS, access to one base/reference station is enough for a mobile to communicate.

Furthermore, Trilateration accuracy is sensitive to the geometry of reference stations vs. receiver. As well known in the art, a poor geometry, i.e. low volume formed by the positions of the satellites and receiver, causes poor (high) DOP (dilution of position). In this context, cellular/WLAN Trilateration is expected to suffer worse VDOP (Vertical DOP) than GPS, due to the typically common level deployment of base stations. This poor nature of cellular/WLAN infrastructure particularly downgrades the height (or elevation or altitude) accuracy, in a way that such methods could hardly distinguish between near floors in a high building.

Another present art method to cope with indoors navigation is Dead Reckoning.

Dead reckoning (DR) is a method of navigation, estimating the current position based on a previously determined position (fix), and measuring distance and direction of advancing from that position. In particular, accelerometers or inertial sensors are used to determine the movement acceleration vectors (in two or three dimensions), from which the distance and direction can be derived.

Though inertial systems used to be popular in submarines and airplanes, small and low cost accelerometers can be found nowadays in smart phones.

The combination of GPS to fix an outdoor position, with inertial sensors for dead reckoning, is not new and been applied in submarines and airplanes for many years.

Yet, it is an object of the present invention to provide a method for indoors GPS positioning.

It is another object of the present invention to provide indoors GPS positioning with good altitude accuracy.

It is then an object of the present invention to provide indoors GPS positioning, deploying a modest infrastructure.

It is yet another object of the present invention to provide a method for indoors GPS positioning, configured for elevators, which are major entrances to buildings.

It is a further object of the present invention to provide a method for indoors navigation, combining GPS positioning and dead reckoning, by standard mobile devices.

It is also an object of the present invention to provide a method for indoors navigation, combining GPS positioning and other methods of radio navigation, based on standard communication networks.

### REFERENCES

IS-GPS-200E 8 Jun. 2010
GLOBAL POSITIONING SYSTEM WING (GPSW)
SYSTEMS ENGINEERING & INTEGRATION
INTERFACE SPECIFICATION
IS-GPS-200 Revision E
Navstar GPS Space Segment/Navigation User Interfaces
IS-GPS-800A 8 Jun. 2010
GLOBAL POSITIONING SYSTEM WING (GPSW)
SYSTEMS ENGINEERING & INTEGRATION
INTERFACE SPECIFICATION
IS-GPS-800 Revision A
Navstar GPS Space Segment/User Segment L1C Interface
How Accurate is a Radio Controlled Clock? by Michael A Lombardi
http://tf.nist.gov/general/pdf/2429.pdf
GPS-based time and frequency solutions, BY DAVE JAHR, KEN HARTMAN and KEITH LOISELLE,
Connor-Winfield, Aurora, Ill., www.conwin.com.

Other objects and advantages of the invention will become apparent as the description proceeds.

### SUMMARY OF THE INVENTION

The invention is directed to a method for positioning, configuring a radio beacon coupled to an altimeter to be deployed in an elevator, and to force a nearby GNSS receiver to read constant latitude and constant longitude, and altitude associated with said altimeter input to beacon.

This way, a standard GPS receiver could be used for indoors navigation, though with some limits, however avoiding deployment of huge indoors infrastructure. The present invention is focused on elevators as preferred places for positioning a GPS receiver, since elevators are usually very popular portals to buildings, and since it is possible to use a modest infrastructure per elevator and provide position fix at all the floors that this elevator serves. Moreover, elevators are usually configured to detect and display the nearest floor, so the present invention discloses reading this information and translate it to “GPS language”, for indoors navigation. Furthermore, the present invention discloses a method to proceed with indoor navigation, after leaving the elevator, using the position fix acquired in the elevator, and augment it with data acquired from additional navigation resources, typically embedded in a mobile device, such as an accelerometer or the mobile radio or a WLAN radio.

As a person skilled in the art appreciates, an altimeter is an instrument used to measure the altitude of an object above a fixed level.

According to the present invention, said altimeter is at least one of: elevator car display, elevator shaft floor indicator, elevator linear position sensor, barometer, radar, echo sounder, optical sensor, magnetic sensor.

Since elevators (also known as lifts) typically obtain robust and reliable sensors to determine the floor level, e.g. elevator shaft floor sensor (also known as linear position sensor), and means to indicate said level in the elevator car, e.g. elevator car display, the beacon, preferably, is coupled to said display, either by electrical or optical interfacing. In addition, the beacon is configured, per specific installation, with a reference table associating each floor with a certain altitude above mean sea level.

Further, the present invention discloses configuring said beacon to emulate signals broadcast by GNSS satellites, each signal specifying transmission time instant and an imaginary satellite position, said transmission time instant accounting for the distance between said satellite and said beacon.

Preferably, said satellites not in view where said beacon is deployed.

As a person skilled in the art may appreciate, this is done in order to avoid conflicts at the GNSS receiver, between signals that represent a same satellite but different attributes such as orbits.

As a person skilled in the art probably appreciates, Global Navigation Satellite Systems (GNSSs) such as the GPS, GLONNAS and Galileo, are based on Trilateration. Basically, a GNSS receiver determines its range, from a GNSS satellite, by measuring the travelling time of a signal broadcast by this satellite to said receiver, and multiplying this travelling time by the speed of light in free space [C]. Knowing also the satellite position, the receiver basically determines a sphere in space on which it is located.

The travelling time of the signal is basically determined as the difference between the receiving time instant, measured at the receiver, and the signal transmission time instant, reported by the satellite in the navigation message modulating this signal. Furthermore, a fast spreading sequence, known in the art as PRN, also modulates the signal, enabling the receiver to refine this range determination.

The present invention discloses replacing the satellite with a beacon, typically deployed in an elevator, where GPS satellite signals are probably not available, and configuring this beacon to broadcast signals similar to those broadcast by the satellites. As well known in the art, the specifications of such signals are defined and published in GPS documents, as indicated in the background of the invention chapter.

However, differently than the satellites, the disclosed beacon does not report its own position, but an imaginary position, preferably on a Keplerian orbit around the center of the earth, typically far away from the actual position of the beacon. And also differently than the satellites, the disclosed beacon does not report the real transmission time instant of each of the signals it broadcast, but corrects it according to the distance between its actual position and the imaginary position that it reports.

Thus, if the beacon reports a reference position which is C*t1 m (wherein C is the speed of light in free space in m/sec and t1 is a time interval in seconds) away from its actual position, it will specify a transmission time instant t1 seconds earlier than the real time, faking a signal that was supposedly broadcast from that imaginary satellite position and already traveled C*t1 m to the actual position of the beacon, from which the signal is actually transmitted.

A nearby GPS receiver will thus determine its position on a sphere in space whose center is the imaginary satellite position and its radius is C*t1.

The disclosed beacon is configured to broadcast four such signals, each emulating an imaginary satellite, each signal defining a sphere on which a nearby GPS receiver is placed. This nearby GPS receiver will then determine its position on one of two points common to all those four spheres.

The signals broadcast from the beacon are configured so that one of said two points will read the latitude and longitude of the actual position of the beacon in the elevator, which is constant and configured into the beacon per specific installation, and the altitude of the elevator, which changes as the elevator moves, yet is constantly read by an altimeter coupled to said beacon.

This configuration is reflected in the PRN and navigation message, and is well known in the art, particularly in GPS signal simulators. Obviously, said imaginary satellite may be positioned even on the other side of the earth, as the signal is actually transmitted from the beacon, which is close enough to the GPS receiver. Typically, the beacon is installed in a high place in the elevator, preferably on the ceiling, radiating to the elevator car. The nearby GPS receiver is preferably also in the elevator car, or by such a car.

The present invention further discloses coupling said beacon to a source providing accurate timing signals, substantially synchronized with GPS Time or with Universal Time Coordinated (UTC).

As already discussed in the background of the invention chapter, the GPS is synchronized to a master clock or time reference named “GPS Time”, administered by the ground segment of the system, based on atomic clocks, and accordingly uploaded to the satellites. GPS Time is synchronized with UTC(USNO), up to some leap seconds that are updated from time to time. As well known in the art, many terrestrial systems are synchronized to UTC or GPS Time, and broadcast this timing, such as terrestrial radio navigation systems, communication networks and national or regional time transmitters.

Since elevators are usually connected with electrical wires, it is possible for the beacon to couple to an accurate timing source through cables. However, preferably, the beacon is configured with a wireless receiver to detect said accurate timing signals.

Preferably, according to the present invention, the beacon signals emulate GPS satellites, and these signals are synchronized with said source providing accurate timing, in order to broadcast accurate transmission time instant. In particular, the PRN timing and parts in the navigation message that relate to the satellite timing, such as the HOW word and the satellite clock correction to GPS time, are synchronized with said accurate source.

The invention is also directed to a radio beacon coupled to an altimeter for positioning in elevator, configured to force a nearby GNSS receiver to read constant latitude and constant longitude, and altitude associated with said altimeter input to beacon.

According to the present invention, said altimeter is at least one of: elevator car display, elevator shaft floor indicator, elevator linear position sensor, barometer, radar, echo sounder, optical sensor, magnetic sensor.

Further according to the present invention, said beacon is configured to emulate signals broadcast by GNSS satellites, each of said signals specifying transmission time instant and an imaginary satellite position, said transmission time instant accounting for the distance between said imaginary satellite and said beacon.

Preferably, said satellites are not in view where said beacon is deployed.

Further, the present invention discloses that said beacon is coupled to a source providing accurate timing signals, at least one of: GNSS receiver, Radio Navigation System, radio clock, Radio Controlled Clock (RCC), radio time signal stations, Digital Terrestrial Television (DTT), Radio Data System (RDS), Wide Area Network (WAN), wireless WAN, cellular or mobile network, Local Area Network (LAN), wireless LAN, Personal Area Network (PAN), crystal oscillator, atomic clock.

An example of a radio navigation system is LORAN. A major radio time signal station is the US NIST (National Institute of Standards and Technology) WWVB, in Colorado, broadcasting signals to synchronize consumer electronic products, network time and frequency calibrations.

Preferably, the beacon is coupled to a receiver that can detect said accurate timing signals indoors. Though GNSS signals can hardly be detected indoors, it is possible to detect such signals outdoors, and modulate the timing information acquired from the GPS, on radio carriers more suitable indoors.

Many other radio timing signals are already configured for indoors detection, such as LORAN, the WWVB, DTT, RDS, WLAN (WIFI or WIMAX), and cellular communications.

The invention is further directed to a portable device comprising a GNSS receiver and at least an additional navigation resource; said device configured to fix its GNSS position or altitude, in elevator, and navigate relatively to said fix using inputs from said resource.

The present invention discloses for said device that said resource is a sensor or data base, said sensor is at least one of: clock, accelerometer, barometer, altimeter, thermometer, compass, step counter, wireless radio, microphone, camera; and said data base comprises at least one of: digital map, reference point, distance to reference point, direction to reference point, attribute of reference point, sound, picture, video clip.

Preferably, said device is a cellular phone, also known as smart phone, comprising a GPS receiver and optionally also an accelerometer. Several such products are already available in the market, by Apple (iPhone), Samsung, Motorola, Sony-Ericsson, Google and others.

This way, once such a mobile user fixes its position or altitude in the elevator, and walks out, he or she can further navigate indoors, using data provided by said embedded resource.

As well known in the art, inertial sensors and accelerometers provide relatively good accuracy for short terms, due to their accumulative drift. Similarly can be considered a compass output. Thus, the combination between a GPS fix and a short term (some minutes or so) dead reckoning using one or more: accelerometer, inertial sensor, compass, step counter (a device that senses and counts steps and translates these into distance, upon calibration; typically used by runners to measure the distance made) is quite efficient.

As a person skilled in the art may appreciate, “dead reckoning” is the process of calculating one's current position by using a previously determined position, or fix, and advancing that position based upon known or estimated speeds over elapsed time, and course, and time.

A mobile device with built in GPS may be used, according to the present invention, to fix the altitude in the elevator, using the GPS receiver, and then navigate using signals from cellular base stations, or wLAN (such as WIFI or WIMAX) Access Points (APs), or even Personal Area Networks (PANs, such as Blue Tooth) APs, in case that said mobile device is configured so. Navigation relatively to such stations is typically done, as well known in the art, by TOA (Time of Arrival) or AOA (Angle of Arrival) methods, or variations thereof (such as DTOA—Differential TOA). However, as already indicated in the background of the invention chapter, such terrestrial reference stations for Trilateration might present poor VDOP, so an initial altitude fix acquired in the elevator can significantly contribute for further indoor navigation based on WAN or LAN stations.

Furthermore, once a mobile user is out of the elevator, upon acquiring a confident position fix, it is possible to further navigate according to sights or sounds nearby, compared to replicas thereof stored in the mobile device. For example, if a specific store in a mole plays a specific piece of music or tones, known and recorded in said mobile device data base, said mobile device can be configured to indicate the user the direction and or distance to said store.

Moreover, as known in the art, a digital map can be used for “map matching” the GPS fix. Preferably, said device comprises a three dimensional digital map of a building, including accurate indication of elevators. Then, upon acquiring a GPS position in the elevator, the device is configured to correct the altitude to the nearest floor, as recorded in the digital map, assuming that an altitude between floors is not relevant to the user, even in the elevator and especially after leaving the elevator.

Further, the present invention discloses that a radio beacon coupled to an altimeter is installed in said elevator, said beacon configured to force a nearby GNSS receiver to read constant latitude and constant longitude, and altitude associated with said altimeter input to beacon.

Further, said altimeter is at least one of: elevator car display, elevator shaft floor indicator, elevator linear position sensor, barometer, radar, echo sounder, optical sensor, magnetic sensor.

Moreover, the present invention discloses for said device that said beacon is configured to emulate signals broadcast by GNSS satellites, each of said signals specifying transmission time instant and an imaginary satellite position, said transmission time instant accounting for the distance between said satellite and said beacon.

Preferably, said satellites are not in view where said beacon is deployed.

Furthermore, the present invention discloses for said device that said beacon is coupled to a source providing accurate timing signals, substantially synchronized with GPS Time or with Universal Time Coordinated (UTC).

The invention is additionally directed to a computer program product in a computer readable medium for indoors navigation comprising:

a) for a respective beacon, means for configuring constant latitude and constant longitude;
b) for a respective beacon, means for determining altitude according to input from altimeter;
c) for a respective beacon, means for broadcasting signals emulating GNSS satellites, configured to force a nearby GNSS receiver to read constant latitude and constant longitude, and altitude according to said altimeter input to beacon;
d) for a respective mobile device, means for acquiring position or altitude fix from a GNSS receiver;
e) for a respective mobile device, means for acquiring data from an additional navigation resource;
f) for a respective mobile device, means for navigating according to said fix and said data.

Furthermore, the present invention discloses for said computer program product that said resource is a sensor, at least one of: clock, accelerometer, barometer, altimeter, thermometer, compass, step counter, wireless radio, microphone, and camera.

Also disclosed for said computer program product that said resource is a data base, comprising at least one of: digital map, reference point, distance to reference point, direction to reference point, attribute of reference point, sound, picture, video clip, navigation aiding text.

The above examples and description have been provided for the purpose of illustration, and are not intended to limit the scope of the invention in any way. As will be appreciated by the skilled person, the invention can be carried out in a variety of ways, not limited by specific terms or specific interpretations of terms as described above, all without exceeding the scope of the invention.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates the Basic GPS Trilateration Concept. The earth globe is represented by a circle, on which the map of the world is illustrated. Three satellites are depicted orbiting in space, around the earth, positioned at (x₁, y₁, z₁), (x₂, y₂, z₂) and (x₃, y₃, z₃), respectfully.

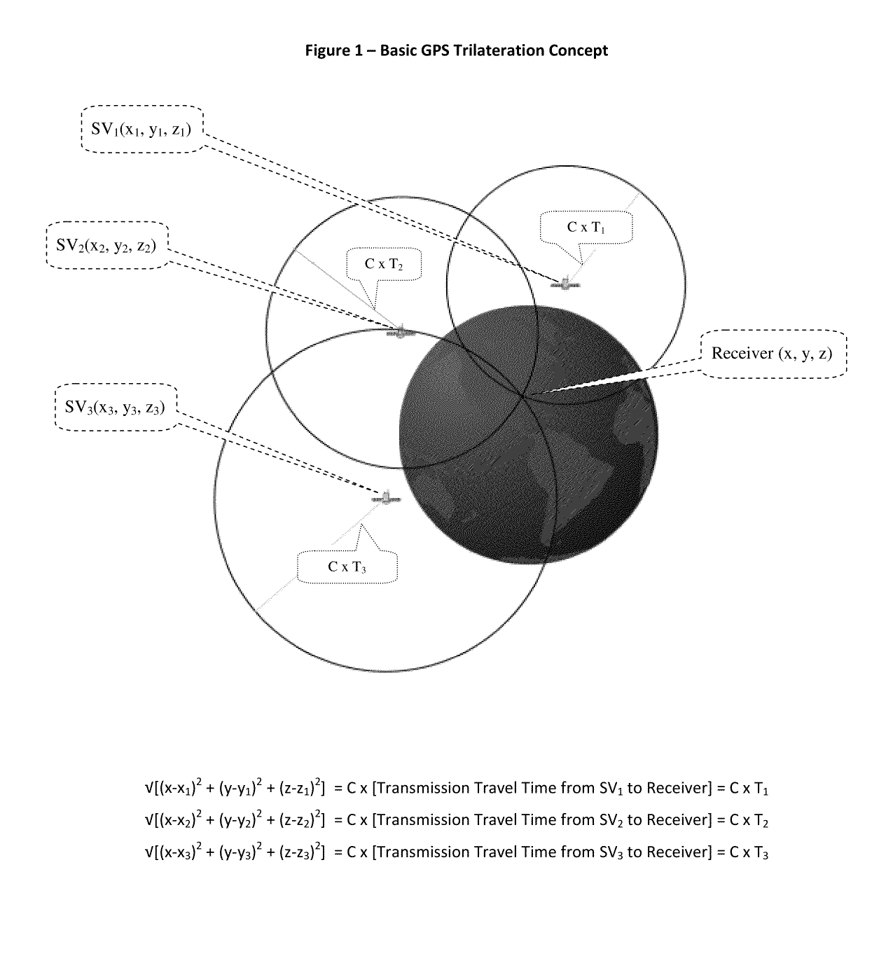

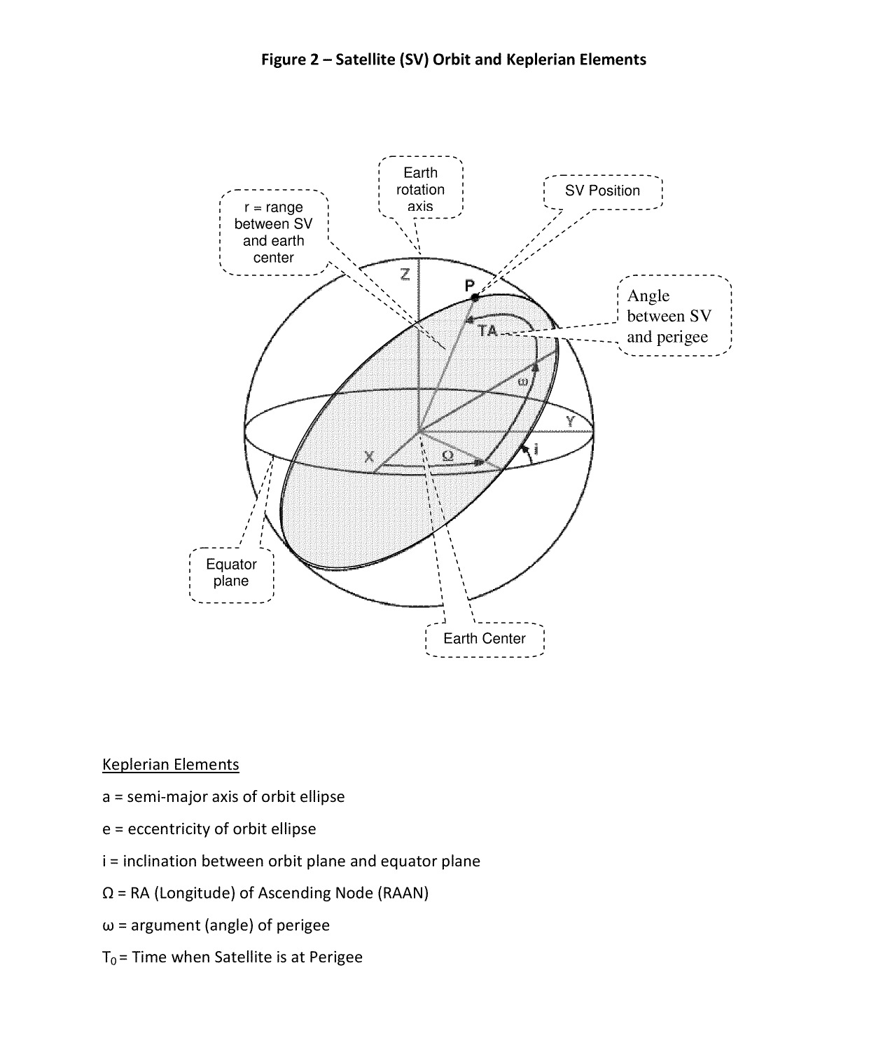

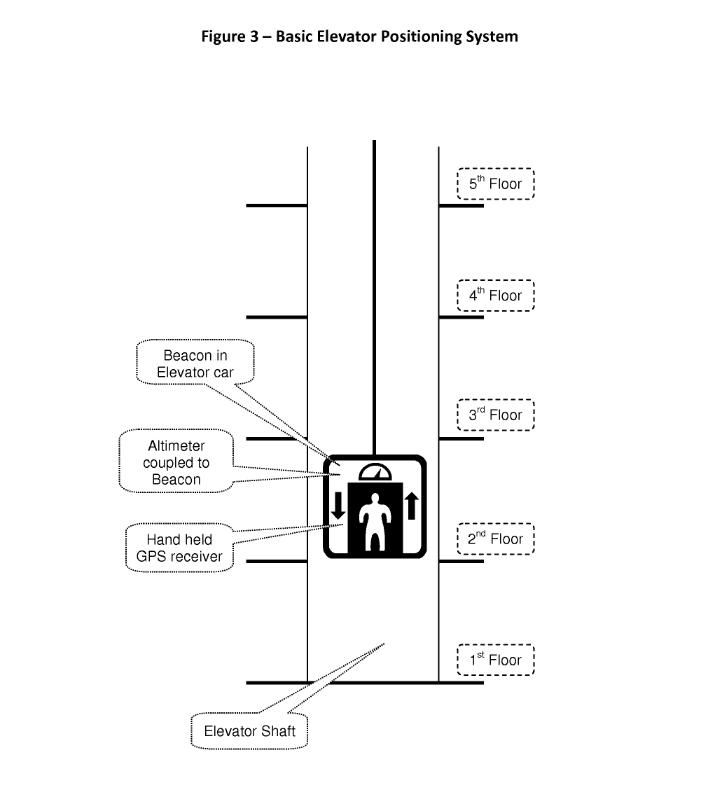

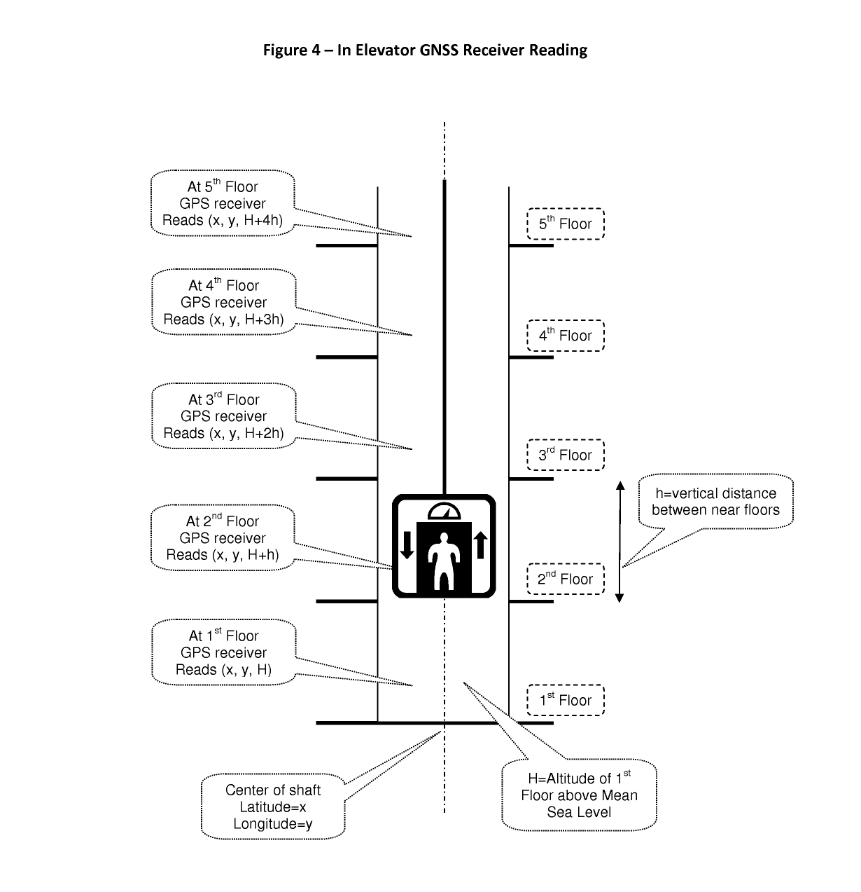

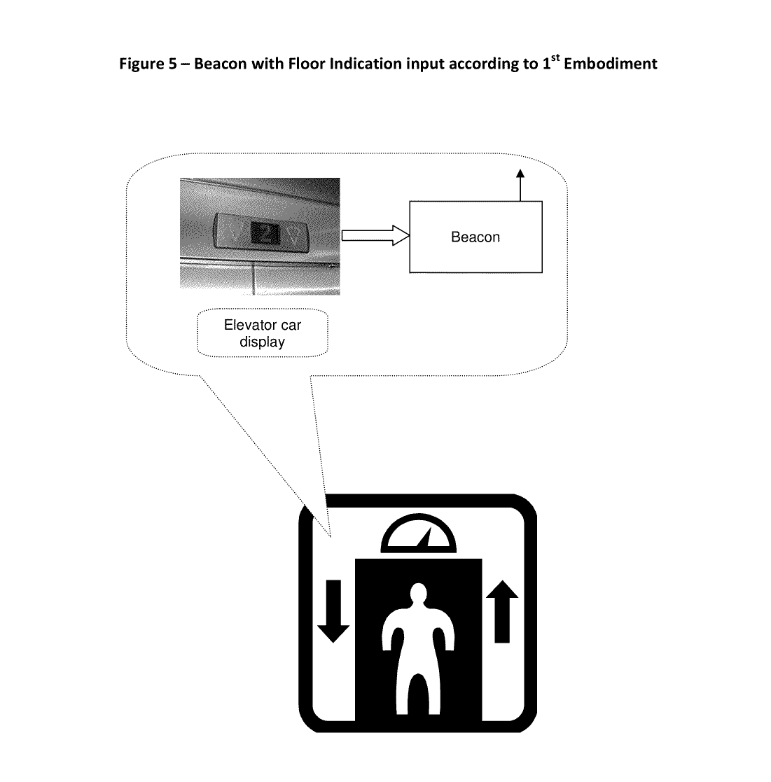

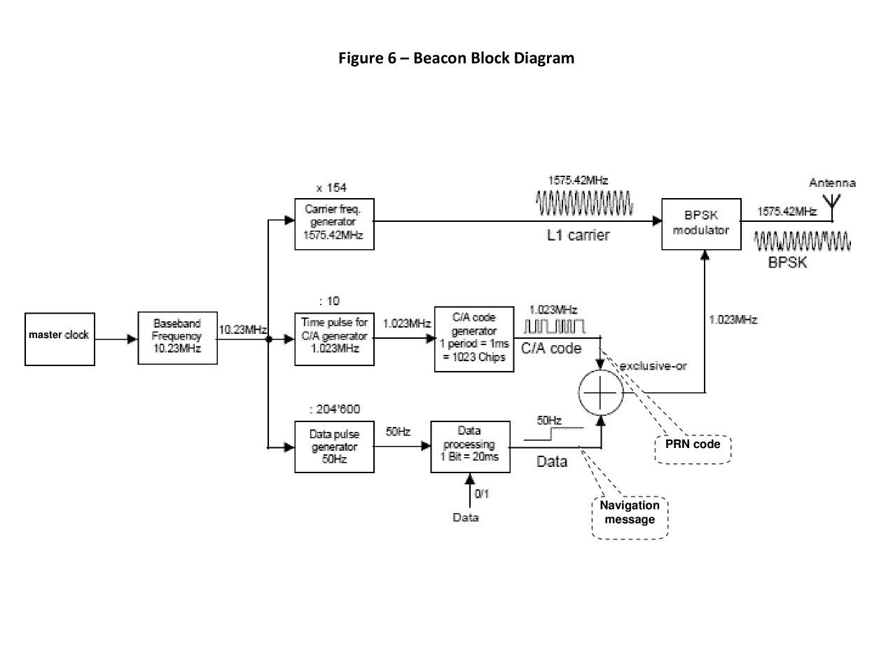

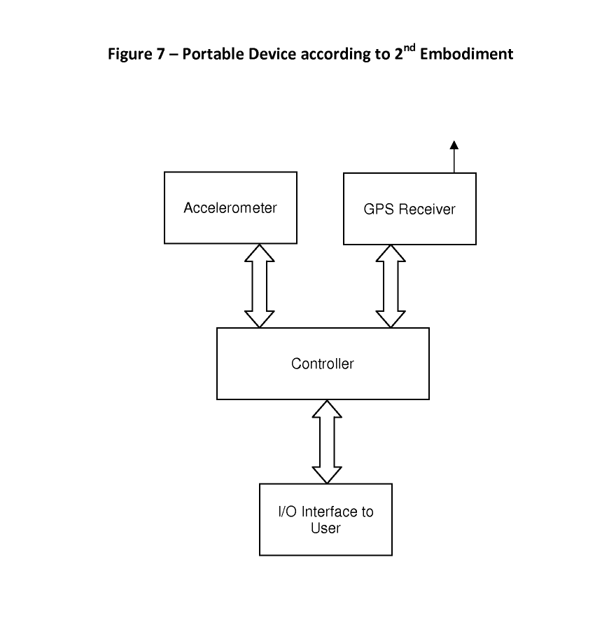

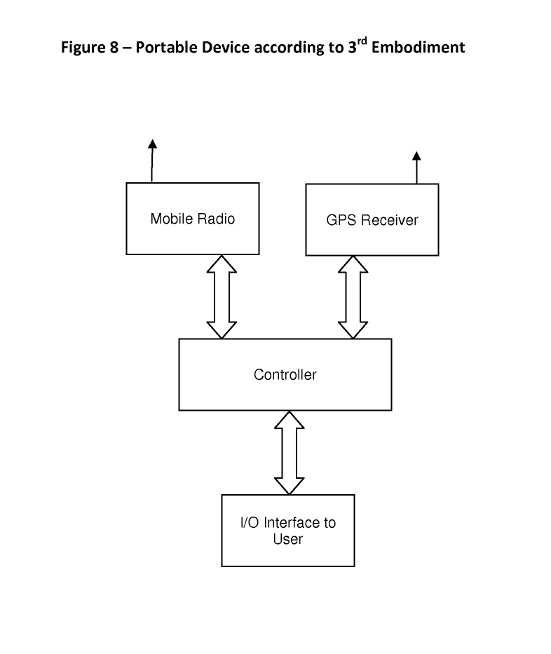

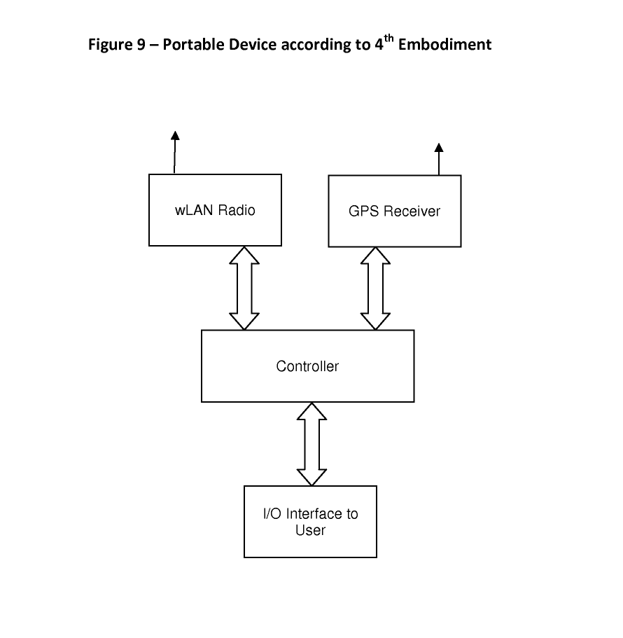

A receiver depicted on the earth surface, with position coordinates (x, y, z). Three circles, each around a different satellite, with radii of C×T₁, C×T₂ and C×T₃, accordingly, depict the range from each satellite to the receiver, said three circles intersecting at the receiver. At the bottom of the picture, the three navigation equations representing the basic Trilateration method, are shown:

√[(x−x₁)²+(y−y₁)²+(z−z₁)²]=C×[Transmission Travel Time from SV₁ to Receiver]=C×T₁

√[(x−x₂)²+(y−y₂)²+(z−z₂)²]=C×[Transmission Travel Time from SV₂ to Receiver]=C×T₂

√[(x−x₃)²+(y−y₃)²+(z−z₃)²]=C×[Transmission Travel Time from SV₃ to Receiver]=C×T₃

FIG. 2 illustrates the Satellite (SV) Orbit and its Keplerian Elements.

The satellite orbit is depicted in a three dimensional Cartesian coordinate system, with the earth center at the origin, X-axis and Y-axis on the equator plane and Z-axis aligned with the earth rotation axis. The earth equator plane illustrated horizontally, the satellite orbit plane shown inclined at angle (i) to the equator plane, and crossing the equator plane at angle Ω from the X-axis. Angle ω indicates the direction of the semi major axis of the orbit ellipse, also known as perigee.

At the bottom of the picture, the six Keplerian Elements are defined:

a=semi-major axis
e=eccentricity
i=inclination between orbit plane and equator plane

### Ω=RA (Longitude) of Ascending Node (RAAN)

ω=argument (angle) of perigee
T₀=Time when Satellite is at Perigee (=closest to earth)

FIG. 3 illustrates a Basic Elevator Positioning System according to the present invention. A five floors building with an elevator shaft in the middle column is depicted, and an elevator car inside said shaft, is shown, at the second floor level. It is indicated that a beacon is deployed in the elevator car, coupled to an altimeter. A hand held GPS receiver is also indicated to be in the elevator car.

FIG. 4 illustrates the In Elevator GNSS Receiver Reading according to the present invention. A five floors building with an elevator shaft in the middle column is depicted, and an elevator car is shown in said shaft, at the second floor level. The Latitude and Longitude coordinates of the center of the shaft are x and y, correspondingly, and the Altitude of the first floor above sea level is H, as indicated in the picture. Also indicated in the picture is that the vertical distance between floors is h. At the left side of each floor, the GPS receiver reading, corresponding to that floor, is indicated, as following:

At the first floor the GPS receiver reads (x, y, H);
At the second floor the GPS receiver reads (x, y, H+h);
At the third floor the GPS receiver reads (x, y, H+2h);
At the fourth floor the GPS receiver reads (x, y, H+3h);
At the fifth floor the GPS receiver reads (x, y, H+4h).

FIG. 5 illustrates the Beacon with Floor Indication input according to a 1^{st} Embodiment of the present invention. The elevator car, and a floor display in it, is shown. The display shows the second floor and arrows indicating going down (↓2↓). A beacon is shown coupled to said display. An antenna is illustrated on the beacon.

FIG. 6 illustrates the Beacon Block Diagram, according to a preferred embodiment of the present invention. From left side, a master clock block is depicted, generating a basic frequency of 10.23 MHz used to derive the carrier frequency L1=1575 MHz (upper branch), the PRN code at 1.023 MHz (center branch), and the Data (navigation message) clock at 50 Hz (lower branch). The navigation message is depicted as the Data output from the Data processing block (lower branch), and the C/A PRN code is depicted as the output of the C/A code generator (center branch). A round circle with an internal plus sign illustrates the exclusive-or (XOR) function employed on the data and PRN code, and a BPSK block illustrates the modulation of said XOR product on the L1 carrier, resulting with a signal to be transmitted, by the antenna shown at the upper-right side of the picture.

FIG. 7 illustrates a block diagram of a Portable Device according to a 2^{nd} Embodiment of the present invention. A main block is shown depicting the controller, typically a microprocessor or microcontroller, coupled to a GPS receiver (an antenna shown coupled to) and to an accelerometer. From its other side, the controller is coupled to an I/O interface block, typically implemented by a display and keyboard (or touch panel).

FIG. 8 illustrates a block diagram of a Portable Device according to a 3^{rd} Embodiment of the present invention. A main block is shown depicting the controller, typically a microprocessor or microcontroller, coupled to a GPS receiver (an antenna shown coupled to) and to a mobile radio. From its other side, the controller is coupled to an I/O interface block, typically implemented by a display and keyboard (or touch panel).

FIG. 9 illustrates a block diagram of a Portable Device according to a 4^{th} Embodiment of the present invention. A main block is shown depicting the controller, typically a microprocessor or microcontroller, coupled to a GPS receiver (an antenna shown coupled to) and to a wLAN radio. From its other side, the controller is coupled to an I/O interface block, typically implemented by a display and keyboard (or touch panel).

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

The invention is directed to a method for positioning, configuring a radio beacon coupled to an altimeter to be deployed in an elevator, and to force a nearby GNSS receiver to read constant latitude and constant longitude, and altitude associated with said altimeter input to beacon.

According to the present invention, said altimeter is at least one of: elevator car display, elevator shaft floor indicator, elevator linear position sensor, barometer, radar, echo sounder, optical sensor, magnetic sensor.

FIG. 3 illustrates a Basic Elevator Positioning System according to the present invention. A five floors building with an elevator shaft in the middle column is depicted, and an elevator car inside said shaft, is shown, at the second floor level. It is indicated that a beacon is deployed in the elevator car, coupled to an altimeter. A hand held GPS receiver is also indicated to be in the elevator car.

FIG. 4 illustrates the In Elevator GNSS Receiver Reading according to the present invention. A five floors building with an elevator shaft in the middle column is depicted, and an elevator car is shown in said shaft, at the second floor level. The Latitude and Longitude coordinates of the center of the shaft are x and y, correspondingly, and the Altitude of the first floor above sea level is H, as indicated in the picture. Also indicated in the picture is that the vertical distance between floors is h. At the left side of each floor, the GPS receiver reading, corresponding to that floor, is indicated, as following:

At the first floor the GPS receiver reads (x, y, H);
At the second floor the GPS receiver reads (x, y, H+h);
At the third floor the GPS receiver reads (x, y, H+2h);
At the fourth floor the GPS receiver reads (x, y, H+3h);
At the fifth floor the GPS receiver reads (x, y, H+4h).

According to the present invention, the beacon is configured with these x, y, H and h parameters, according to the specific deployment site. To be more precise, x and y refer to the exact position of the beacon (not necessarily in the center of the elevator shaft), and H is the 1^{st} floor altitude measured at about 1 meter from the floor level, where a hand held device is typically located.

FIG. 5 illustrates the Beacon with Floor Indication input according to a 1^{st} Embodiment of the present invention. The elevator car, and a floor display in it, is shown. The display shows the second floor and arrows indicating going down (↓2↓). A beacon is shown coupled to said display. An antenna is illustrated on the beacon.

Not shown in this picture the nature of coupling between the floor display and the beacon. Yet according to the 1^{st} embodiment of the present invention, the beacon is configured with a small CMOS camera to read the floor display of the elevator (possibly through a beam splitter). The beacon is also configured with a reference table (in software) associating each and every reading of the elevator display with a certain offset above (or under, for basement floors, underground garage, etc.) the first floor level H.

Further, the present invention discloses configuring said beacon to emulate signals broadcast by GNSS satellites, each signal specifying transmission time instant and an imaginary satellite position, said transmission time instant accounting for the distance between said satellite and said beacon.

Then, according to a preferred embodiment of the present invention, the beacon is configured, to broadcast GPS alike signals, forcing a nearby GPS receiver to read a position (x, y, z), where x and y are constant, as initially configured into the beacon, and z=H+[said table offset], wherein the entry to said table is determined in real time, according to the current elevator floor display.

FIG. 6 illustrates the Beacon Block Diagram, according to the preferred embodiment of the present invention. From left side, a master clock block is depicted, generating a basic frequency of 10.23 MHz used to derive the carrier frequency L1=1575 MHz (upper branch), the PRN code at 1.023 MHz (center branch), and the Data (navigation message) clock at 50 Hz (lower branch). The navigation message is depicted as the Data output from the Data processing block (lower branch), and the C/A PRN code is depicted as the output of the C/A code generator (center branch). A round circle with an internal plus sign illustrates the exclusive-or (XOR) function employed on the data and PRN code, and a BPSK block illustrates the modulation of said XOR product on the L1 carrier, resulting with a signal to be transmitted, by the antenna shown at the upper-right side of the picture.

According to the preferred embodiment of the present invention, the signals broadcast by said beacon emulate GPS signals. Furthermore, the navigation message broadcast by said beacon is configured to specify Keplerian Elements indicating the position of an imaginary satellite. Basically, configuring the beacon to emulate GPS alike signals is done according to the US GPS Interface Specifications, a set of documents well known in the art, as indicated in the background of the invention chapter.

The navigation message is further configured, according to said preferred embodiment, to specify a transmission time instant accounting for the distance between said imaginary satellite and said beacon, i.e. earlier by [distance between satellite and beacon]/C, and so is also configured the PRN code which modulates the signal.

This can be implemented by modifying one or more of the following: the transmission time stamp in the navigation message, the phase of the PRN code, or the satellite clock corrections to GPS time.

As a skilled person may appreciate, the time stamp in the navigation message is implemented in the HOW word contained in every subframe, in a format known as Z-Count. Yet, Z-Count represents the transmission time instant in ×1.5 seconds steps so for the present invention suits only for coarse corrections.

However, shifting the C/A PRN by one chip, configures a delay of 1 microsecond, equivalent to 300 meters, which provides a good resolution for the purpose of the present invention, since GPS satellites are typically 67,000 microseconds away (in light speed terms, i.e. about 20,000 Kilometers) from earth surface. Obviously, it is possible to manipulate the PRN timing and phase by fractions of a chip and achieve finer corrections.

The satellite clock correction to GPS time is represented by three parameters, broadcast in subframe one of the navigation message. These parameters, assigned a_{f0}, a_{f1} and a_{f2}, are coefficients for a clock correction formula, well known in the art, where a_{f0} is the clock offset in seconds, a_{f1} is the linear drift rate in seconds per second, and a_{f2} is the quadratic clock error in seconds per seconds squared, all referring to a specific time epoch. These parameters are represented in the navigation message at a very high resolution, for example a_{f0} Least Significant Bit (LSB) is 10⁻³¹ seconds, so may be quite useful for fine tuning the transmission time instant, according to the present invention.

GPS satellites broadcast another correction to the clock that can be used to modify the transmission time instant according to the present invention: group delay to calculate the Ionospheric delay.

It is to be noted that a GPS satellite clock is configured considering relativistic effects, which should be differently considered regarding to terrestrial beacons. According to Special Relativity the frequency of atomic clocks moving at orbital speeds are slower than stationary ground clocks. According to General Relativity, a clock away to a massive object runs faster than a close clock, so satellite clocks are faster than clocks on earth. Combining both effects, the discrepancy is ^{˜}38 μs/day. To offset that, satellite atomic clocks are set prior to launch at 10.22999999543 MHz instead of 10.23 MHz. This is not required for the present invention, since elevators in terrestrial buildings typically do not move so fast as GPS satellites and are not as far from the earth surface.

Further according to said preferred embodiment of the present invention, the beacon emulates a satellite not in view in the area where said beacon is deployed. As a person skilled in the art may appreciate, and as published by the GPS ICD, GNSSs assign parameters (e.g. ID, PRN) defining more satellites than are actually deployed. Some of these satellite assigned parameters are still unused, while others are used by Satellite-Based Augmentation Systems (SBAS), such as WAAS (above the USA), EGNOS (above Europe), MSAS (above Japan) and GAGAN launched to cover India. SBAS is a system of satellites and ground stations providing GPS signal corrections, improving position accuracy and alerting for service issues. All SBASs comply with a common global standard and are interoperable and compatible with standard GPS receivers.

More information can be found at:

http://egnos-portal.gsa.europa.eu/discover-egnos/about-egnos/what-is-sbas-

So according to the preferred embodiment of the present invention, beacons deployed in the USA will be configured with EGNOS PRN codes, or MSAS codes, or GAGAN codes, or unused GPS codes. Similarly, beacons deployed in Europe will be configured with WAAS or MSAS or GAGAN codes, or unused GPS codes, and so on.

The present invention further discloses coupling said beacon to a source providing accurate timing signals, substantially synchronized with GPS Time or with Universal Time Coordinated (UTC).

Said source for providing accurate timing signals, is at least one of: GNSS receiver, Radio Navigation System, radio clock, Radio Controlled Clock (RCC), radio time signal stations, Digital Terrestrial Television (DTT), Radio Data System (RDS), Wide Area Network (WAN), wireless WAN, cellular or mobile network, Local Area Network (LAN), wireless LAN, Personal Area Network (PAN), crystal oscillator, atomic clock.

Theoretically, as long as the beacon broadcasts signals emulating four satellites, wherein these signals are synchronized among themselves, a GPS receiver can perfectly resolve the four navigation equations, and determine its position coordinates (x, y, z) and its internal clock deviation from GPS Time (Δt_{R}) as elaborated on the background of the invention chapter. Yet, if this GPS receiver is also used outdoors, detecting real GPS satellites which their time reference is different than the emulated satellites time reference, there might be a conflict that will influence the GPS receiver operation.

Therefore, according to the 1^{st} embodiment of the present invention, a GPS receiver is installed near the elevator, coupled to an outdoor GPS antenna. Said receiver is coupled to the beacon in the elevator, through the elevator cables, and the time message output from the GPS receiver, along with the 1PPS pulse, are read by the beacon. The beacon is further configured with an internal TCXO, which is configured as a reference Local Oscillator (LO) to an embedded Phase Lock Loop (PLL), said PLL configured to lock on said 1PPS pulse. Such a mechanism is well known in the art.

See for example the article: GPS-based time and frequency solutions, BY DAVE JAHR, KEN HARTMAN and KEITH LOISELLE, Connor-Winfield, Aurora, Ill., www.conwin.com.

The invention is also directed to a radio beacon coupled to an altimeter for positioning in elevator, configured to force a nearby GNSS receiver to read constant latitude and constant longitude, and altitude associated with said altimeter input to beacon.

According to the present invention, said altimeter is at least one of: elevator car display, elevator shaft floor indicator, elevator linear position sensor, barometer, radar, echo sounder, optical sensor, magnetic sensor.

Further according to the present invention, said beacon is configured to emulate signals broadcast by GNSS satellites, each of said signals specifying transmission time instant and an imaginary satellite, position, said transmission time instant accounting for the distance between said imaginary satellite and said beacon.

Preferably, said satellites are not in view where said beacon is deployed.

The invention is further directed to a portable device comprising a GNSS receiver and at least an additional navigation resource; said device configured to fix its GNSS position or altitude, in elevator, and navigate relatively to said fix using inputs from said resource.

The present invention discloses for said device that said resource is a sensor or data base, said sensor is at least one of: clock, accelerometer, barometer, altimeter, thermometer, compass, step counter, wireless radio, microphone, camera; and said data base comprises at least one of: digital map, reference point, distance to reference point, direction to reference point, attribute of reference point, sound, picture, video clip.

FIG. 7 illustrates a block diagram of a Portable Device according to a 2^{nd} Embodiment of the present invention. A main block is shown depicting the controller, typically a microprocessor or microcontroller, coupled to a GPS receiver (an antenna shown coupled to) and to an accelerometer. From its other side, the controller is coupled to an I/O interface block, typically implemented by a display and keyboard (or touch panel).

According to the 2^{nd} embodiment of the present invention, said device is configured to fix its GPS position in the elevator, then navigate relatively to said fix using inputs from said accelerometer. So, the accelerometer is initialized upon fixing the position in the elevator, then configured to provide the acceleration vector, i.e. amount and direction of acceleration; the controller is configured to integrate said acceleration over time, to calculate the speed, and integrate the speed to determine the distance made, and direction followed, from said elevator fix.

FIG. 8 illustrates a block diagram of a Portable Device according to a 3^{rd} Embodiment of the present invention. A main block is shown depicting the controller, typically a microprocessor or microcontroller, coupled to a GPS receiver (an antenna shown coupled to) and to a mobile radio. From its other side, the controller is coupled to an I/O interface block, typically implemented by a display and keyboard (or touch panel).

According to the 3^{rd} embodiment of the present invention, said device is a cellular smart phone, configured to fix its GPS altitude in the elevator, then navigate relatively to said fix using inputs from said mobile (i.e. cellular, i.e. WAN) radio. The mobile radio is configured to detect signals broadcast by three nearby cellular base stations, which specify their exact position and transmission time instant. Then, the device is configured to resolve four Trilateration equations (similar to the GPS navigation equations), referring to said three cellular base station signals and the altitude acquired from the GPS in the elevator. One way to do so is to translate the GPS acquired altitude to parameters that simulate an imaginary fourth base station, placed in the center of the earth, as it broadcast a signal that traveled [R+Alt]/C until detected by said mobile device, wherein R=radius of the earth, Alt=altitude acquired by the GPS receiver in the elevator, and C=speed of light.

FIG. 9 illustrates a block diagram of a Portable Device according to a 4^{th} Embodiment of the present invention. A main block is shown depicting the controller, typically a microprocessor or microcontroller, coupled to a GPS receiver (an antenna shown coupled to) and to a wLAN radio. From its other side, the controller is coupled to an I/O interface block, typically implemented by a display and keyboard (or touch panel).

According to the 4^{th} embodiment of the present invention, said device is configured similarly to according said 3^{rd} embodiment just that said three signals from cellular base stations are replaced with similar signals from wLAN APs.

As a skilled person may appreciate, a device comprising a GPS receiver as well as a WAN radio and a LAN radio, may combine both 3^{rd} and 4^{th} embodiments, i.e. use signals broadcast by WAN base stations as well as signals broadcast by LAN APs, altogether three such signals are required. Such an approach is more practical since it is not likely to be in a position to simultaneously detect three WAN base stations.

Obviously, fusion of more sensors inputs, such as from an accelerometer, may improve the navigation accuracy.

Preferably, said mobile device is also configured with a three dimensional digital map, indicating the landscape at each floor of the building. Said “landscape” typically shows places of interest such as: elevators, stairs, stores, offices, apartments, banks, vending machines, and information desks.

Further, the present invention discloses for said portable device, that a radio beacon coupled to an altimeter is installed in said elevator, said beacon configured to force a nearby GNSS receiver to read constant latitude and constant longitude, and altitude associated with said altimeter input to beacon.

Further, said altimeter is at least one of: elevator car display, elevator shaft floor indicator, elevator linear position sensor, barometer, radar, echo sounder, optical sensor, magnetic sensor.

FIG. 3 illustrates the in-elevator beacon and altimeter configured for said portable device.

Moreover, the present invention discloses for said device that said beacon is configured to emulate signals broadcast by GNSS satellites, each of said signals specifying transmission time instant and an imaginary satellite position, said transmission time instant accounting for the distance between said satellite and said beacon.

Preferably, said satellites are not in view where said beacon is deployed.

Furthermore, the present invention discloses for said device that said beacon is coupled to a source providing accurate timing signals, substantially synchronized with GPS Time or with Universal Time Coordinated (UTC).

The invention is additionally directed to a computer program product in a computer readable medium for indoors navigation comprising:

a) for a respective beacon, means for configuring constant latitude and constant longitude;
b) for a respective beacon, means for determining altitude according to input from altimeter;
c) for a respective beacon, means for broadcasting signals emulating GNSS satellites, configured to force a nearby GNSS receiver to read constant latitude and constant longitude, and altitude according to said altimeter input to beacon;
d) for a respective mobile device, means for acquiring position or altitude fix from a GNSS receiver;
e) for a respective mobile device, means for acquiring data from an additional navigation resource;
f) for a respective mobile device, means for navigating according to said fix and said data.

Furthermore, the present invention discloses for said computer program product that said resource is a sensor, at least one of: clock, accelerometer, barometer, altimeter, thermometer, compass, step counter, wireless radio, microphone, and camera.

Also disclosed for said computer program product that said resource is a data base, comprising at least one of: digital map, reference point, distance to reference point, direction to reference point, attribute of reference point, sound, picture, video clip, navigation aiding text.

According to a 5^{th} embodiment of the present invention, a system for car positioning in a huge underground garage is deployed, wherein in each elevator serving said garage, a beacon is installed. Each beacon is coupled to the floor display of the elevator car, as according to the 2^{nd} embodiment of the present invention. Users of cellular phones with embedded GPS receiver and accelerometer (i.e. smart phones, such as iPhone by Apple and Galaxy II by Samsung) are offered an application for positioning the car they park in said garage. This application, i.e. computer program product in a computer readable medium, is configured to:
a. Upon parking, record the path made from the car to any elevator in the building, based on the accelerometer readings;
b. Upon entering a first elevator, fix the position and transform said recorded path to absolute coordinates;
c. When returning to the car, navigate the user from any elevator in the building to the car.

The above examples and description have been provided for the purpose of illustration, and are not intended to limit the scope of the invention in any way. As will be appreciated by the skilled person, the invention can be carried out in a variety of ways, not limited by specific terms or specific interpretations of terms as described above, all without exceeding the scope of the invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

The invention claimed is:

1. A method for positioning, configuring a radio beacon coupled to an altimeter to be deployed in an elevator, and to force a nearby GNSS receiver to read constant latitude and constant longitude, and altitude associated with said altimeter input to beacon.

2. A method according to claim 1, said altimeter is at least one of: elevator car display, elevator shaft floor indicator, elevator linear position sensor, barometer, radar, echo sounder, optical sensor, magnetic sensor.

3. A method according to claim 1, configuring said beacon to emulate signals broadcast by GNSS satellites, each signal specifying transmission time instant and an imaginary satellite position, said transmission time instant accounting for the distance between said satellite and said beacon.

4. A method according to claim 3, wherein said satellites not in view where said beacon is deployed.

5. A method according to claim 1, coupling said beacon to a source providing accurate timing signals, substantially synchronized with GPS Time or with Universal Time Coordinated (UTC).

6. A radio beacon coupled to an altimeter for positioning in elevator, configured to force a nearby GNSS receiver to read constant latitude and constant longitude, and altitude associated with said altimeter input to beacon.

7. A beacon according to claim 6, said altimeter is at least one of: elevator car display, elevator shaft floor indicator, elevator linear position sensor, barometer, radar, echo sounder, optical sensor, magnetic sensor.

8. A beacon according to claim 6, configured to emulate signals broadcast by GNSS satellites, each of said signals specifying transmission time instant and an imaginary satellite position, said transmission time instant accounting for the distance between said imaginary satellite and said beacon.

9. A beacon according to claim 8, wherein said satellites not in view where said beacon is deployed.

10. A beacon according to claim 6, coupled to a source providing accurate timing signals, at least one of: GNSS receiver, Radio Navigation System, radio clock, Radio Controlled Clock (RCC), radio time signal stations, Digital Terrestrial Television (DTT), Radio Data System (RDS), Wide Area Network (WAN), wireless WAN, cellular or mobile network, Local Area Network (LAN), wireless LAN, Personal Area Network (PAN), crystal oscillator, atomic clock.

11. A portable device comprising a GNSS receiver and at least an additional navigation resource, said device configured to fix its GNSS position or altitude, in elevator, and navigate relatively to said fix using inputs from said resource.

12. A device according to claim 11, wherein said resource is a sensor or data base, said sensor is at least one of: clock, accelerometer, barometer, altimeter, thermometer, compass, step counter, wireless radio, microphone, camera; and said data base comprises at least one of: digital map, reference point, distance to reference point, direction to reference point, attribute of reference point, sound, picture, video clip.

13. A device according to claim 11, a radio beacon coupled to an altimeter installed in said elevator, said beacon configured to force a nearby GNSS receiver to read constant latitude and constant longitude, and altitude associated with said altimeter input to beacon.

14. A device according to claim 13, said altimeter is at least one of: elevator car display, elevator shaft floor indicator, elevator linear position sensor, barometer, radar, echo sounder, optical sensor, magnetic sensor.

15. A device according to claim 13, said beacon configured to emulate signals broadcast by GNSS satellites, each of said signals specifying transmission time instant and an imaginary satellite position, said transmission time instant accounting for the distance between said satellite and said beacon.

16. A device according to claim 15, wherein said satellites not in view where said beacon is deployed.

17. A device according to claim 13, said beacon coupled to a source providing accurate timing signals, substantially synchronized with GPS Time or with Universal Time Coordinated (UTC).

18. A computer program product in a computer readable medium for indoors navigation comprising:
a) for a respective beacon, means for configuring constant latitude and constant longitude;
b) for a respective beacon, means for determining altitude according to input from altimeter;
c) for a respective beacon, means for broadcasting signals emulating GNSS satellites, configured to force a nearby GNSS receiver to read constant latitude and constant longitude, and altitude according to said altimeter input to beacon;
d) for a respective mobile device, means for acquiring position or altitude fix from a GNSS receiver;
e) for a respective mobile device, means for acquiring data from an additional navigation resource;
f) for a respective mobile device, means for navigating according to said fix and said data.

19. A computer program product according to claim 18, wherein said resource is a sensor, at least one of: clock, accelerometer, barometer, altimeter, thermometer, compass, step counter, wireless radio, microphone, camera.

20. A computer program product according to claim 18, wherein said resource is a data base, comprising at least one of: digital map, reference point, distance to reference point, direction to reference point, attribute of reference point, sound, picture, video clip, navigation aiding text.
